(19) United States
(12) Patent Application Publication
(10) Pub. No.: US 2009/0322207 A1
(43) Pub. Date: Dec. 31, 2009

(54) LIGHT-EMITTING SCREEN AND IMAGE DISPLAYING APPARATUS

(75) Inventors: Ginjiro Toyoguchi, Tokyo (JP); Tomoya Onishi, Ayase-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/486,091

(22) Filed: Jun. 17, 2009

(30) Foreign Application Priority Data
Jun. 27, 2008 (JP) 2008-169324

(51) Int. Cl. H01J 1/62

(52) U.S. Cl. 313/495

(57) ABSTRACT

To prevent deterioration of an image based on a halation phenomenon due to secondary reflected electrons at the top of a rib member provided between light-emitting members for interrupting reflected electrons, an aperture portion for capturing the secondary reflected electrons is provided at a portion, positioned between the light-emitting members, on the rib member for separating the light-emitting members.

### BACKGROUND OF THE INVENTION

1. Field of the Invention

The present invention relates to a light-emitting screen which is used for an image displaying apparatus.

2. Description of the Related Art

Conventionally, a field emission display (FED) has been known as an image displaying apparatus. The FED has a vacuum container which is formed by bonding a rear plate and a light-emitting screen through a frame member. Further, plural electron-emitting devices are arranged in matrix on the rear plate. Furthermore, red (R), green (G) and blue (B) light-emitting members which respectively emit visible light in response to electrons emitted by the electron-emitting devices, black members each of which is positioned between the light-emitting members, and anode electrodes which are to accelerate the electrons are arranged on the light-emitting screen. Here, a metal back which consists of a metal film such as Al or the like has been generally known as the anode electrode.

In the FED of such a constitution, a phenomenon that, in a case where the electrons emitted from the electron-emitting devices enter the metal backs and the light-emitting members on the light-emitting screen, a part of the emitted electrons are reflected has been confirmed. That is, the electrons reflected by the metal backs and the light-emitting members (called the reflected electrons hereinafter) are again accelerated toward the side of the light-emitting screen due to the voltage between the anode electrodes and the electron-emitting devices, and the accelerated electrons reenter the light-emitting members, whereby a phenomenon called halation occurs.

Here, it should be noted that the halation is the phenomenon that the electrons reflected by the metal backs and the light-emitting members enter the light-emitting members in another region adjacent. More specifically, if the halation occurs, since the light-emitting members in the region not selected emit light, contrast and color purity wholly deteriorate, whereby image quality deteriorates. For this reason, measures against the halation have been considered so far.

Incidentally, Japanese Patent Application Laid-Open No. 2008-097861 (corresponding to United States Patent Publication No. 2008/084160) discloses that a rib is provided between light-emitting members on a light-emitting screen so as to control occurrence of halation by interrupting reflected electrons.

However, as for the rib disclosed in Japanese Patent Application Laid-Open No. 2008-097861, it has been requested to further reduce the halation occurring due to the reflected electrons. In this connection, the present invention aims to provide a new light-emitting screen which can reduce halation occurring due to reflected electrons and an image displaying apparatus which uses the new light-emitting screen.

### SUMMARY OF THE INVENTION

The present invention which solves such a problem as described above is characterized by a light-emitting screen which comprises: a substrate; anode electrodes positioned on the substrate; plural light-emitting members adapted to emit light in response to irradiation of electrons; and rib members, positioned among the plural light-emitting members, adapted to mutually separate the plural light-emitting members, wherein the rib member has an aperture portion between the adjacent light-emitting members mutually separated by the rib member.

According to the present invention, it is possible to further reduce the halation occurring due to the reflected electrons, and it is thus possible to display a high-quality image.

Further features of the present invention will become apparent from the following description of the exemplary embodiments with reference to the attached drawings.

### BRIEF DESCRIPTION OF THE DRAWINGS

FIGS. 1A and 1B are views respectively illustrating an example of the structure of a light-emitting screen according to the present invention.

FIGS. 2A and 2B are views respectively illustrating another example of the structure of a light-emitting screen according to the present invention.

FIG. 3 is a cross-sectional view along the line 3-3 indicated in FIG. 1A.

FIG. 4 is a cross-sectional view along the line 4-4 indicated in FIG. 2A.

FIG. 5 is a conceptual perspective view of partially cutting off an image displaying apparatus according to the present invention.

FIG. 6 is a cross-sectional view along the line 6-6 indicated in FIG. 5.

FIG. 7 is a view indicating a relationship between an aperture ratio of an aperture portion of a rib member and the reflected electron amount.

FIGS. 8A, 8B and 8C are views indicating a manufacturing process of the light-emitting screen according to the present invention.

FIGS. 9A, 9B and 9C are views indicating a manufacturing process of the light-emitting screen according to the present invention.

FIGS. 10A and 10B are views indicating a manufacturing process of the light-emitting screen according to the present invention.

FIGS. 11A and 11B are views indicating a manufacturing process of the light-emitting screen according to the present invention.

### DESCRIPTION OF THE EMBODIMENTS

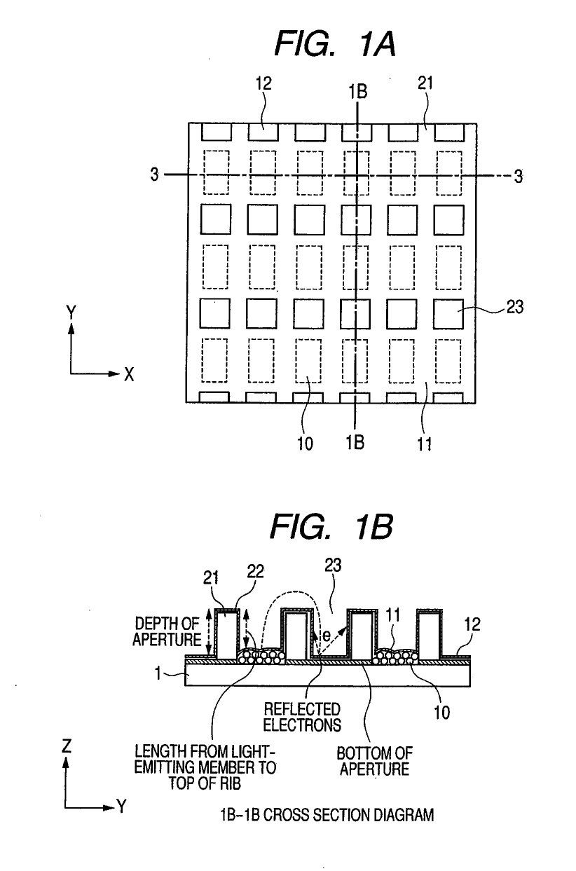

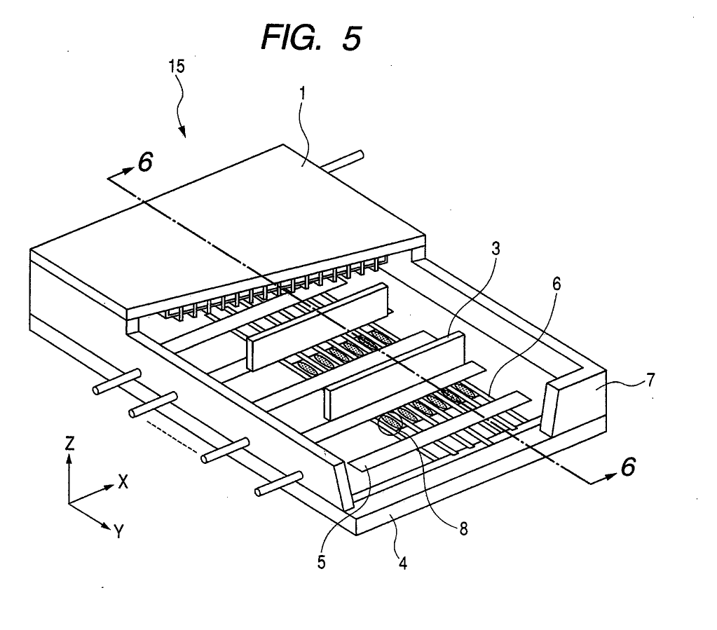

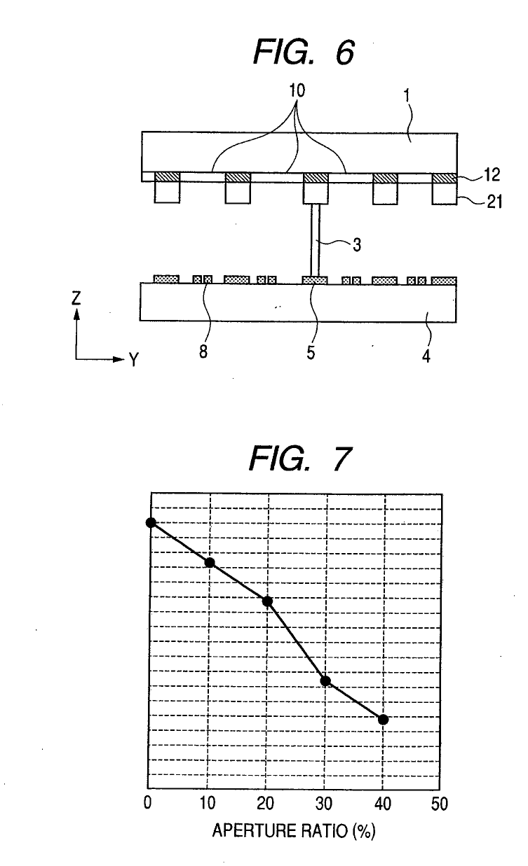

Hereinafter, the exemplary embodiment of the present invention will be described with reference to FIGS. 1A, 1B, 2A, 2B, 3, 4, 5, 6 and 7. FIG. 1A is a plane view of a light-emitting screen of the present embodiment, and FIG. 1B is a cross-sectional view in case of cutting off the light-emitting screen of the present embodiment along the line 1B-1B indicated in FIG. 1A. FIGS. 5 and 6 are views respectively illustrating the whole outline of an image displaying apparatus of the present embodiment, and FIG. 5 is a whole perspective view of partially cutting off the image displaying apparatus and FIG. 6 is a cross-sectional view along the line 6-6 indicated in FIG. 5. First of all, the light-emitting screen, which is a characteristic part, will be described.

In the present embodiment, as illustrated in FIGS. 1A and 1B, metal films 11, which are conductive members, for constituting anode electrodes, phosphor layers 10, which are plural light-emitting members, for displaying an image and rib members 21, which separate the respective phosphor layers 10, are formed on a face substrate 1. The light-emitting screen in the present embodiment is composed of the face substrate 1, the metal films 11, which are the conductive members, for constituting the anode electrodes, the phosphor layers 10 which are the plural light-emitting members and the rib members 21. As for the light-emitting screen, the constitution of further having a black matrix 12 serving as a black member is preferable according to the structure of the image displaying apparatus as illustrated in FIGS. 1A and 1B.

In FIG. 1B, the phosphor layers 10 which are the light-emitting members are separated each other by the rib members 21 positioned on the substrate. The rib members 21 have aperture portions 23 between the phosphor layers 10 which are the adjacent light-emitting members separated each other by the rib members. In the present embodiment, as illustrated in FIG. 1B, electrons which could not be shielded by the rib members 21 among the reflected electrons generated at the metal films 11 or the phosphor layers 10 are incident to the face substrate 1 again to generate new reflected electrons (secondary reflected electrons indicated by a dot-line arrow in FIG. 1B). However, the secondary reflected electrons can be shielded by the aperture portions 23. When it is described in detail, although electrons which are incident to the aperture portions 23 generate the secondary reflected electrons, since the energy of the electrons is lost due to a fact that the electrons collide with the rib members 21 in the aperture portions 23, the secondary reflected electrons are faded away without exiting from the aperture portions 23 to the outside. Therefore, since the halation can be decreased by shielding the new reflected electrons (secondary reflected electrons) by means of the rib members at the aperture portions, an image having the high contrast can be displayed.

Note that height of the rib members 21 can be properly set in accordance with the specification of the image displaying apparatus. It is preferable that the height of the rib members 21 is set to a range from ½ to 10 times as much as the width (length in the X or Y direction in FIG. 1A) of the phosphor layers, for example, if the width of a light-emitting region is 50 μm, it is preferable that the height of the rib members 21 is set to a range from 25 μm to 500 μm. The shape of the aperture portion provided between the rib members 21 is not specially limited to a rectangle but may be a polygon or a circular form. In addition, it is preferable to constitute that the width of the rib members has the same length in the X direction and the Y direction. In order to effectively shield the reflected electrons at the aperture portions 23, it is preferable that an aperture depth (length in the Z direction in FIG. 1B) of the aperture portion 23 provided between the rib members 21 becomes longer than a length from a surface of the phosphor layer 10, which is the light-emitting member, to a top 22 of the rib member 21. According to this constitution, the reflected electrons can be more surely shielded at the aperture portions.

The relationship between a ratio of a project area of the aperture portions 23 projected to the face substrate 1 for a project area obtained by summing up project areas formed when the phosphor layers 10, the rib members 21 and the aperture portions 23 were projected on the face substrate 1 (hereinafter, called an aperture ratio) and the reflected electron amount is indicated in FIG. 7. Note that FIG. 7 indicates data in a case that the height of the rib members 21 is 120 μm and a rate of a project area of the phosphor layers 10 occupying for the summed up projection area of the phosphor layers 10, the rib members 21 and the aperture portions 23 is equal to 30%. As indicated in FIG. 7, when the aperture ratio becomes equal to or larger than 20%, the secondary reflected electron amount is significantly decreased. However, since a rate occupied by the phosphor layer affects the light emission amount and a rate occupied by the rib member affects a shielding effect of the reflected electrons, the rates occupied by these members must be considered. Therefore, it is preferable that an aperture ratio of the aperture portions 23 is equal to or larger than 20% and equal to or less than 40%. As illustrated in FIG. 1B, in the present constitution, a part of the black matrix serving as the black member is included between the face substrate 1 and the aperture portions 23. In a case of this constitution, the contrast deterioration due to a fact of providing the aperture portions 23 can be prevented, and this constitution is more preferable.

Additionally, respective constitutive members for constituting the light-emitting screen will be described in detail.

It is preferable that the rib member 21 is constituted by the material composed of the inorganic mixture having the resistance nearly equal to the dielectric resistance such as a glass material of containing the metal oxides such as a lead oxide, a zinc oxide, a bismuth oxide, a boric oxide, an aluminum oxide, a silicon oxide and a titanium oxide. A method such as a sand blasting method, a photosensitive paste method, an etching method or the like can be used for the patterning of the rib member 21 including the formation of the aperture portion 23.

A phosphor crystal of emitting the light by the electron beam excitation can be used for the phosphor layer of constituting the light-emitting member. As the specific material of the phosphor layer, for example, the phosphor material or the like used in the conventional CRT described in “Phosphor Handbook” (Phosphor Research Society, Ohmsha, Ltd.) can be used. The thickness of the phosphor layer can be properly set according to the acceleration voltage, a grain size of the phosphor and the phosphor-filled density. In a case that the acceleration voltage is in a level from 5 kV to 15 kV, the thickness of the phosphor layer is set to such the thickness of 4.5 μm to 30 μm which is 1.5 to 3 times as many as 3 μm to 10 μm corresponded to the average grain size of the general phosphor and more preferably set to such the thickness of 5 μm to 15 μm. As a method of forming the phosphor layer on a portion between the rib members 21, a screen printing method, a precipitation method, an inkjet method, a micro-dispenser method or the like can be used. The fine patterning of the phosphor layer can be performed by combining a photolithography method, an etching method or the like with the above-described method.

An anode electrode is preferably formed by a metal film as represented by the metal back. The metal film which constitutes the anode electrode has both a function of serving as the anode electrode used for applying the acceleration voltage used for injecting electrons to the phosphor layer by accelerating the electrons and a light reflecting function of reflecting the light emitted to the electron-emitting device side among the luminous flux non-directionally generated at the phosphor layer to the atmosphere side. Therefore, the metal film is placed closer to the electron-emitting device side than the phosphor layer. Since electrons are required to be reached the phosphor layer passing through the metal film, a thickness of the metal layer is properly set in consideration of the energy loss of electrons, the set acceleration voltage and a reflection efficiency of the light. A thickness of the metal film is set to a range from 50 nm to 300 nm for the acceleration voltage in a level from 5 kV to 15 kV. As a material of the metal film, aluminum is generally used. It is allowed that barium or titanium is laminated on a surface of the metal film for the purpose of the gas adsorption and carbon (graphite) or boron nitride is laminated for the purpose of the reduction of reflected electrons. The metal film is deposited by a vacuum vapor deposition method or a sputtering method after depositing an acrylic resin film, a cellulosic resin film or a film of mixing both the acrylic resin and the cellulosic resin on the phosphor layer by a spin coating method, a screen printing method, a spray coating method, a micro-dispenser method or the like. According to a method of forming a resin film, a process of applying a water film on the phosphor layer is sometimes accompanied before forming the resin film. In a baking process after formation of the metal film, the resin film is burned out or decomposed to be eliminated. Note that the anode electrode is not limited to the aluminum positioned closer to the electron-emitting device side than the phosphor layer but may be constituted by a transparent electrode such as an ITO (Indium Tin Oxide) arranged between the phosphor layer and the face substrate.

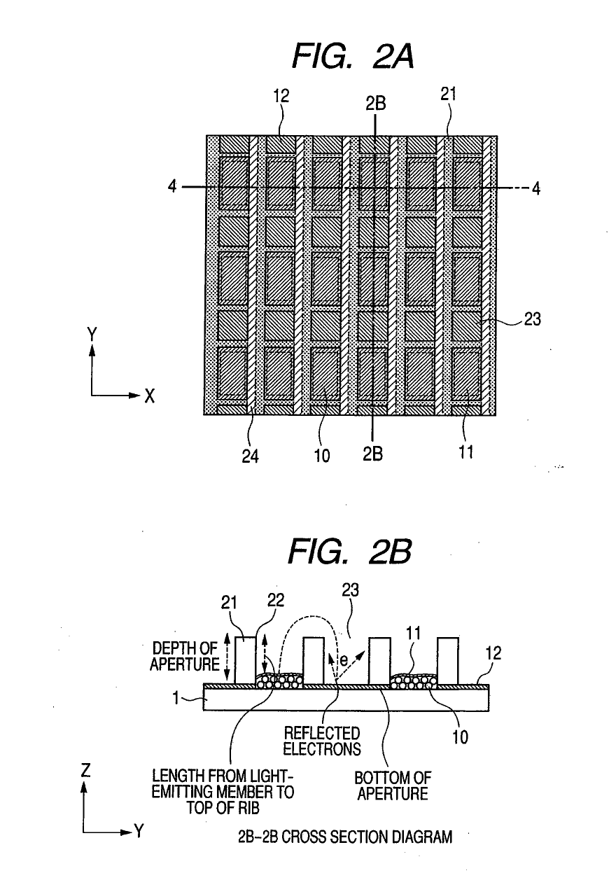

As the anode electrodes, the constitution of having the plural metal films 11 serving as conductive members separately positioned by the rib members 21 and resistive members 24 of connecting the plural metal films serving as the conductive members each other is preferable as illustrated in FIGS. 2A and 2B. In a case that the anode electrodes have such the constitution, operations of the light-emitting screen and an image displaying apparatus of using such the light-emitting screen are stabilized, and this constitution is more preferable. When it will be described in detail, even if an excessive current flowed between the light-emitting screen and a rear plate to be described later, the amount of current can be restricted by the resistive members 24 of connecting the metal films 11 separated each other. Due to the restriction of the above-described amount of current, the stability in an operation of the image displaying apparatus is improved and this stable operation is maintained over a long period of time.

A film thickness (thickness in the Z direction indicated in FIG. 1B) of the black matrix 12 serving as the black member is set to a range from 1 μm to 10 μm in accordance with a kind of the light absorbing substance. The black matrix has such the resistance nearly equal to the dielectric resistance. The black material used for the black matrix 12 is generally a black metal, a black metal oxide or a carbon. As the black metal oxide, for example, ruthenium oxide, chrome oxide, ferric oxide, nickel oxide, molybdenum oxide, cobalt oxide, copper oxide or the like can be enumerated. As the black matrix 12, such a member obtained by performing the pattern forming by the photolithography method after depositing the above-described material by a vacuum deposition method or such a member obtained by performing the pattern forming after electrodepositing the above-described material can be used. In addition, such a member obtained by pattern forming the above-described material by a printing process or such a member obtained by performing the pattern forming by the photolithography method after printing the above-described material having photosensitivity can be also used.

Next, the constitution of the rear plate will be described with reference to FIGS. 5 and 6. Plural electron-emitting devices 8 for emitting electrons used for exciting the phosphor layers 10 to emit the light are provided on an inner face of a rear substrate 4. As the electron-emitting devices 8, for example, surface conduction electron-emitting devices can be preferably used. These electron-emitting devices 8 are arranged in plural columns and plural rows corresponding to the respective phosphor layers, and each of the electron-emitting devices 8 is constituted by an electron-emitting portion, which is not illustrated, and a pair of device electrodes for applying the voltage to this electron-emitting portion. In addition, plural row-directional wirings 5 and plural column-directional wirings 6 used for supplying the driving voltage to the respective electron-emitting devices 8 are provided on the inner face of the rear substrate 4, and edge portions of the wirings are pulled out to the external of a vacuum envelope. The rear plate is constituted by the rear substrate 4, the electron-emitting devices 8, the row-directional wirings 5 and the column-directional wirings 6.

The above-described light-emitting screen and the rear plate are oppositely arranged having a predetermined distance (for example, distance in a range from 0.5 nm to 2.0 nm) due to the interposition of a distance defining member 3. Peripheries of the face substrate 1 of the light-emitting screen and the rear substrate 4 of the rear plate are bonded with each other due to the interposition of a rectangular side wall 7 to constitute a vacuum container of which the inside is depressurized.

In an image displaying apparatus 15 of using the above-described vacuum container, in case of displaying an image, the voltage is supplied to the electron-emitting devices 8 through the row-directional wirings 5 and the column-directional wirings 6 to emit electrons, which are accelerated by the anode voltage applied to the anode electrodes to be irradiated to the phosphor layers 10. Herewith, the desired phosphor layer 10 is excited to emit the light and an image is displayed.

In the above-described image displaying apparatus, the light-emitting members are separated each other by the rib members, and the rib members have an aperture portion on a part between the light-emitting members. According to this constitution, as illustrated in FIGS. 1B and 2B, new reflected electrons (secondary reflected electrons) which are generated when the reflected electrons are incident to the light-emitting screen again can be surely shielded at the aperture portion. Therefore, the halation can be decreased and an image having the high contrast can be displayed.

### EXAMPLE 1

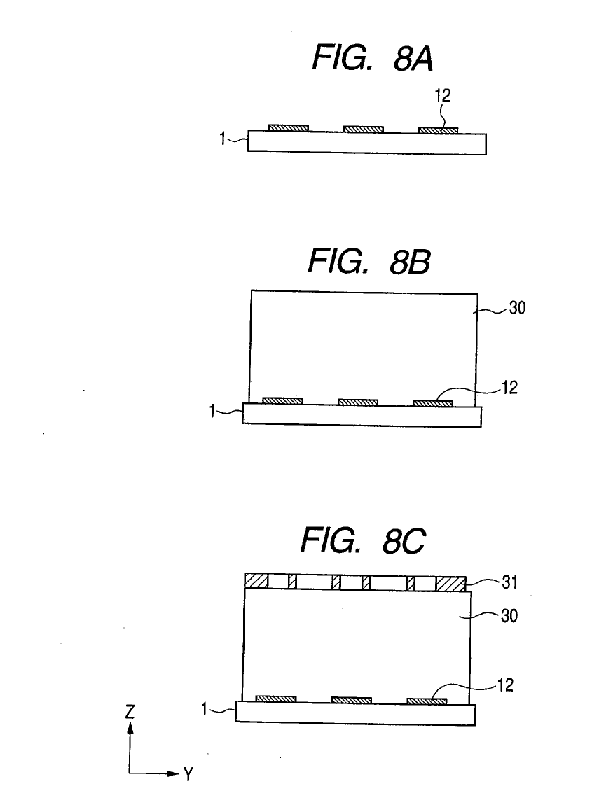

Hereinafter, the example of the present invention will be described. FIGS. 1A and 1B are views illustrating the constitution of a light-emitting screen in an image displaying apparatus of this example. FIGS. 8A, 8B and 8C, FIGS. 9A, 9B and 9C, FIGS. 10A and 10B and FIG. 11A are views used for describing manufacturing processes of the light-emitting screen in the image displaying apparatus of this example. Note that each of the drawings indicating the manufacturing process is a cross-sectional view, of which the cross-sectional direction is same as that of the cross-section along the line 1B-1B indicated in FIG. 1A. Since the constitution of an electron source and the constitution of the image displaying apparatus are same as those in the above-described embodiment, the description thereof will be omitted.

(Process-a)

A black photo-paste is printed at a desired region in a light-emitting region by a screen printing method on a surface of a cleaned soda lime glass. Thereafter, a drying process is executed at the temperature 90° C. and the black photo-paste is exposed in an optimum pattern by using a photolithography technology. Next, the exposed black photo-paste is developed by the sodium carbonate solution of which the concentration is 0.4 Wt %, and unexposed portions are eliminated and the exposed portions are remained. Next, the product material after performing the development is dried.

(Process-b)

The pattern formed in the (Process-a) is baked at the temperature 550° C., and a black matrix layer 12 which is a black member having the thickness 2 μm, was formed. The shape of the black matrix layer is made to be corresponded to the shape of phosphor layers which are light-emitting members to be formed later. In particular, the black matrix is formed on a position between the phosphor layers to contact with the phosphor layers such that pitches of the phosphor layers become 615 μm in the X direction (in the depth direction on a page space) and 205 μm in the Y direction and the size of the respective phosphor layers becomes 295 μm in the Y direction and 145 μm in the X direction (FIG. 8A).

(Process-c)

Next, a zinc oxide insulation paste is applied by a slit-coater and baked at the temperature 120° C. for ten minutes such that a film thickness after the baking process becomes 150 μm, and a rib material layer 30 was formed (FIG. 8B).

(Process-d)

Next, a dry film resist (DFR) 31 is pasted by using a laminator apparatus. Further, a chrome mask to be used for exposure is aligned to a predetermined position and then the DFR is pattern exposed. The shape of a mask to be used for exposure is set to a pattern form similar to that in the above-described black matrix and an aperture corresponding to the aperture portion 23, of which size is 210 μm in the Y direction and 155 μm in the X direction, is further provided such that a part of the black matrix is exposed.

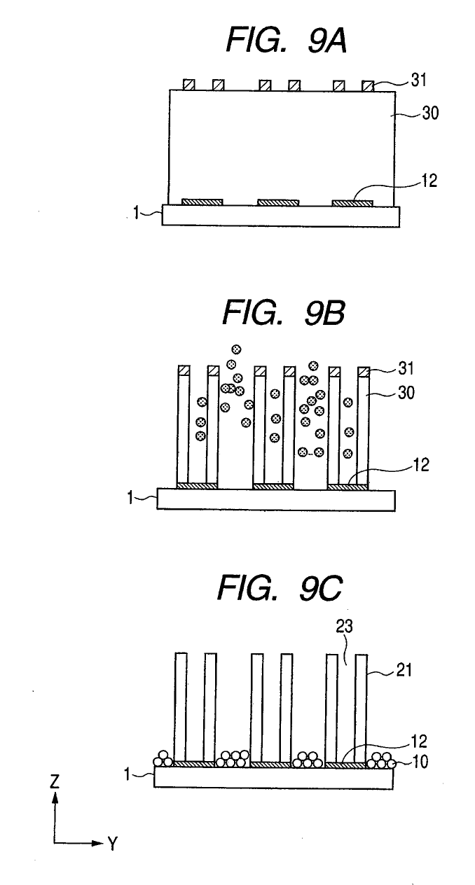

An exposure of the DFR, a developing process, a showering process for the rinse liquid and a drying process are further executed by using this mask to be used for exposure, and a mask (DFR mask), which is to be used for the sand blasting, having apertures on desired positions was formed (FIG. 8C and FIG. 9A).

(Process-e)

Next, portions of an unnecessary rib material layer are eliminated so as to correspond to apertures of the DFR by a sand blasting method, where SUS grains were treated as grinding grains (FIG. 9B).

(Process-f)

Next, the DFR is stripped off by a remover liquid, and the rib material layer was cleaned.

(Process-g)

Next, the rib material layer is baked at the temperature 530° C., and rib members 21 having apertures 23 were formed.

(Process-h)

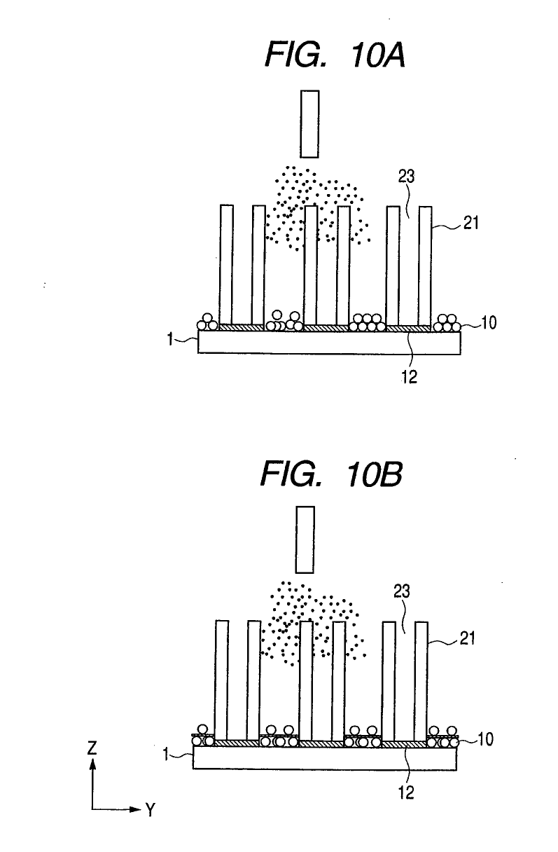

Next, a phosphor layer was printed on a portion between the rib members 21 by a screen printing method by using a paste in which phosphors P22, which are used in a technical field of CRT, are dispersed (FIG. 9C). In this example, phosphor layers of three colors R, G and B are separately coated in the Y direction so as to provide a color display. The thickness of each the phosphor layer was set to 15 μm. The phosphor layers of three colors R, G and B were dried at the temperature 120° C. after the printing. Thereafter, the solution which contains silicate alkali so called a liquid glass acting as a binding agent was applied by a spray coating method (FIG. 10A).

(Process-i)

Next, an acrylic emulsion was applied by the spray coating method and dried, and spaces in the powder phosphors were infilled by the acrylic resin (FIG. 10B).

(Process-j)

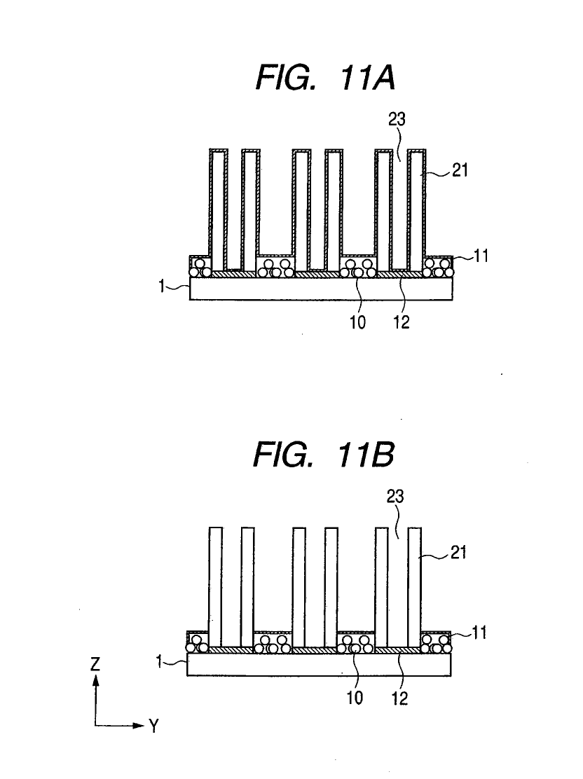

Next, aluminum was vapor deposited on a whole surface of the face substrate, to which the above-described (Process-i) was executed, as a metal film 11 which constitutes anode electrodes. In this case, a thickness of the aluminum was set to 300 nm (FIG. 11A).

(Process-k)

Next, the acrylic resin layer was decomposed to be eliminated by baking it at the temperature 450° C.

The image displaying apparatus was formed by sealing the light-emitting screen formed as mentioned above with the electron source described in the above-described embodiment. And, electrons are emitted by driving the electron-emitting devices through the row-directional wirings and the column-directional wirings, and image was displayed. In this example, the new reflected electrons (secondary reflected electrons) due to the reflected electrons which were incident to the apertures can be shielded as indicated in FIG. 1B by a fact that the rib members have the apertures at portions between the phosphor layers serving as the adjacent light-emitting members separated each other by the rib members. Herewith, a high contrast image of more decreasing the halation can be displayed as compared with a case of not having the apertures.

### EXAMPLE 2

In this example, a point that the constitution illustrated in FIGS. 2A and 2B is adopted as a light-emitting screen is different from a case in Example 1. In this example, the following processes were executed after executing the processes from the (Process-a) to the (Process-i) described in Example 1.

(Process-j)

A resistive member 24 which constitutes the anode electrode was formed on a top of the rib member 21, which positions between the phosphor layers 10 adjacent to each other in the X direction and at a portion of extending in the Y direction in the drawing. This constitution is illustrated in FIG. 2A. As the resistive member 24, a high resistance paste, in which the ruthenium oxide is contained, is formed by a screen printing method such that a film thickness after the baking process becomes 10 μm, and the high resistance paste was baked at the temperature 530° C. after it was dried at the temperature 120° C. for ten minutes.

(Process-k)

Next, aluminum was vapor deposited as metal films 11 serving as the conductive members which constitute anode electrodes. In this case, a mask having aperture portions is used such that the aluminum is vapor deposited from a region, where the phosphor layers 10 serving as the light-emitting members are formed, to side surfaces of the rib members 21 and upper surfaces of the resistive members 24, and a vapor depositing process was executed from the diagonal direction for the face substrate 1. The film thickness of the aluminum was set to 300 nm (FIG. 11B).

(Process-l)

Next, the acrylic resin layer was decomposed to be eliminated by baking it at the temperature 450° C. Also in this example, similar to another example, the new reflected electrons (secondary reflected electrons indicated by a dot-line arrow in FIG. 2B) due to the reflected electrons which were incident to the apertures can be shielded as indicated in FIG. 2B by a fact that the rib members have the apertures at portions between the phosphor layers serving as the adjacent light-emitting members separated each other by the rib members. Herewith, a high contrast image of more decreasing the halation can be displayed as compared with a case of not having the apertures. Further, in this example, it was confirmed that a current which flows between the light-emitting screen and the rear plate when the discharge occurred is more decreased as compared with a case in Example 1 by adopting such the constitution, where the metal film serving as the conductive member is separated in plural portions each other as anode electrodes, which are connected by the resistive members.

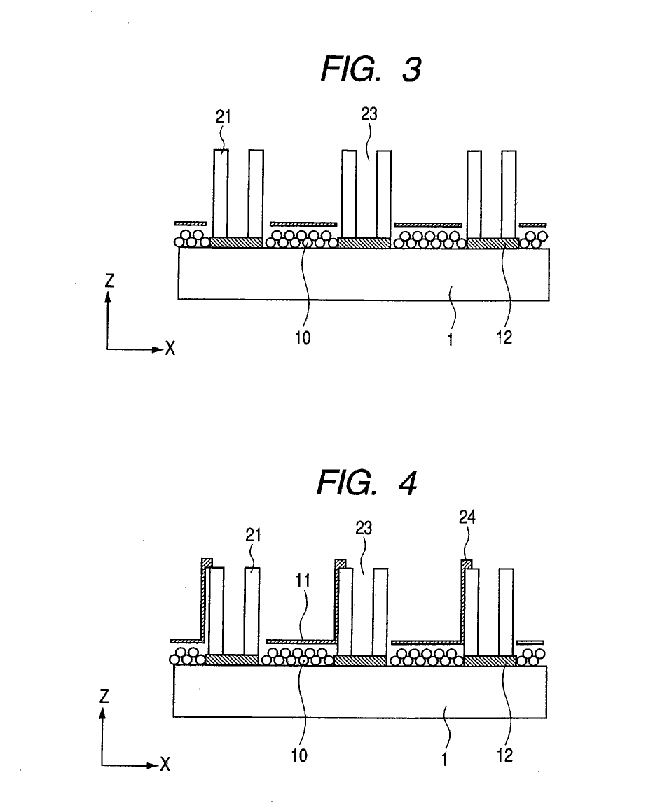

In the above-described respective examples, although the configuration that each of the rib members between the light-emitting members has the aperture at the cross-section along the line 1B-1B indicated in FIG. 1A and the line 2B-2B indicated in FIG. 2A is described, it is not limited to this case but may be constituted that each of the rib members has the aperture 23 at the cross-section in the direction the lines 3-3 and 4-4 indicated in FIGS. 1A and 2A (refer to FIGS. 3 and 4 respectively). In this case, an effect of improving color purity (prevention of color mixture) can be also obtained together with the improvement of the contrast, and this result is more preferable. In addition, it may be constituted that each of the rib members between the light-emitting members has the aperture at both the cross-sections in the direction of the line 1B-1B, the direction of the line 2B-2B and the direction of the lines 3-3 and 4-4 indicated in FIGS. 1A and 2A. In this case, the more improved contrast and color purity can be obtained.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Laid-Open No. 2008-169324, filed Jun. 27, 2008, which is hereby incorporated by reference herein in its entirety.

What is claimed is:

1. A light-emitting screen comprising:
a substrate;
anode electrodes positioned on the substrate;
plural light-emitting members adapted to emit light in response to irradiation of electrons; and
rib members, positioned among the plural light-emitting members, adapted to mutually separate the plural light-emitting members,
wherein the rib member has an aperture portion between the adjacent light-emitting members mutually separated by the rib member.

2. A light-emitting screen according to claim 1, wherein an aperture depth of the aperture portion is longer than a length from the light-emitting members to a top of the rib member.

3. A light-emitting screen according to claim 1, further comprising a black member between the substrate and the aperture portion.

4. A light-emitting screen according to claim 1, wherein the anode electrodes have plural conductive members respectively separated and positioned by the rib members and resistive members for mutually connecting the conductive members.

5. An image displaying apparatus comprising:
a rear plate having electron-emitting devices; and
a light-emitting screen positioned oppositely to the rear plate,
wherein the light-emitting screen is a light-emitting screen according to claim 1.
